(19) United States
(12) Patent Application Publication
(10) Pub. No.: US 2012/0225589 A1
(43) Pub. Date: Sep. 6, 2012

(54) Adapter particularly for adapting light emitting diodes to commercial lamp-holders

(75) Inventor: Marco Bologna, Verona (IT)

(73) Assignee: BIONDAN S.P.A.

(21) Appl. No.: 13/067,916

(22) Filed: Jul. 7, 2011

(30) Foreign Application Priority Data
Mar. 1, 2011 (IT) VR2011U000006

(51) Int. Cl. H01R 33/22

(52) U.S. Cl. 439/661

(57) ABSTRACT

An adapter, particularly for adapting light emitting diodes to commercial lamp-holders, comprising a printed circuit for driving light emitting diodes; the printed circuit has, along its longer sides, engagement elements with a complementary thread of a lamp-holder and, along one of its shorter sides, elastic elements for contact with a lower electric power supply region of the lamp-holder.

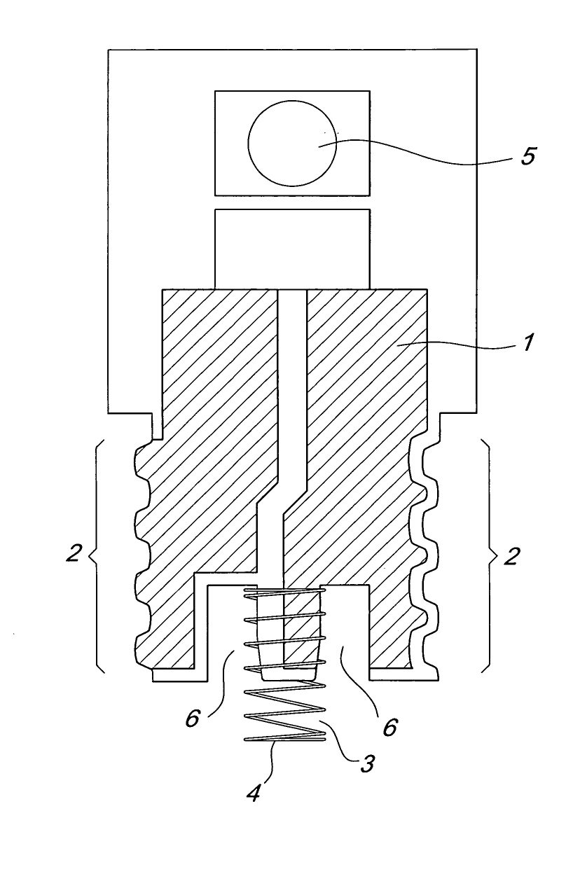

The present invention relates to an adapter, particularly for adapting light emitting diodes to commercial lamp-holders.

### BACKGROUND OF THE INVENTION

As is known from the background art, there are multiple applications of incandescent lamps. In particular, there is a class of incandescent bulbs that have been conceived almost exclusively for use in lamps of particularly small size for particular applications, such as ornamental and decorative lamps.

Moreover, the same class of bulbs is also used in signaling apparatuses, such as control and monitoring panels in thermal or electric power stations or also in generic control rooms where buttons or indicators are arranged, their activation being indicated by the light emitted by said bulbs, especially in systems that have a few years of service.

The characteristics of these bulbs are relatively simple: less than one centimeter in diameter, length of approximately 2÷2.5 centimeters, bulb made of glass with a height of about one centimeter, the remainder being dedicated to the cap for connection to the lamp-holders and to the electrical connection to the power supply circuit. It must also be noted that both the lamp-holders and the bulbs have a standardized thread pitch.

The technical and economic problems that these bulbs have are linked especially to maintenance, or rather to their replacement, because normally the cost of their replacement, wherever they are located, is always very high.

The problem might be reduced drastically, both from an economic point of view and from a technical point of view, by improving the life expectancy of the bulbs: the background art has already provided the solution with light emitting diodes (hereinafter LEDs for the sake of simplicity); they are physically small and have an average lifespan, if used as ordinary bulbs, that is at least ten times longer than the lifespan of standard incandescent lamps.

The problem that arises, therefore, is how to arrange the LEDs in existing lamps: the driving and power supply circuits of the LEDs are in fact usually constituted by a usually rectangular printed circuit board with a thickness of a few millimeters and with dimensions of approximately 2 centimeters in width by 2.5 centimeters in height, with at least one LED positioned on the centerline of one of the two short sides and the electrical connections arranged usually on the other short side, while the printed circuit .board carries the electronics required to electrically convert the voltage from the mains to the power supply voltage of the LED and to convert from alternating current to direct current.

Anyway, various products provided with LED technology that replace incandescent bulbs are already available on the market but are characterized by their dimensions, which are not exactly small. In fact these LED lamps always have the already described printed circuit connected to a part for connection to the electric power supply, which is constituted by a threaded cap that mates with the lamp-holder, and a series of LEDs is arranged on the printed circuit for achieving a brightness that can be compared to the incandescent lamps to be replaced.

The problem posed is of a dimensional type: if the incandescent bulb, as mentioned above, has a height of approximately 2.5 centimeters, in this case, simplifying, the cap can partially contain part of the printed circuit for connection thereto; then there are approximately 1.5-2 centimeters of printed circuit with various enclosures and on top there is a crown of LEDs that extends further upward. It is unlikely that these lamps can replace validly bulbs conceived for use in small spaces such as, for example, operation indicators on a control panel.

Another impediment at this point relates to existing lamp-holders, because it is not economically thinkable to perform complete replacement of all lamp-holders for these types of lamp in whatever situation they might be; replacement costs and times might be absolutely unacceptable both for public managements and private managements.

The lamp-holders have a screw coupling and the electric power supply is divided between a point in the lower central part of said lamp-holder and the thread thereof and in the background art it is practically impossible to simply adapt these power supply printed circuits to these lamp-holders without replacing said lamp-holders.

### SUMMARY OF THE INVENTION

The aim of the present invention is to eliminate or substantially reduce the problems described above by providing an adapter particularly for adapting LEDs to commercial lamp-holders that eliminates the need to replace existing lamp-holders that are already in use.

Within this aim, an object of the present invention is to reduce substantially the maintenance costs of existing systems by eliminating existing bulbs and replacing them with LEDs having a much longer lifespan.

A further object of the present invention is to maintain the status of current electric systems and reduce the frequency of replacement of the lighting elements.

Another object of the present invention is to provide an adapter that is highly reliable, easy to provide and has competitive costs.

This aim and these objects are achieved by an adapter particularly for adapting light emitting diodes to commercial lamp-holders, according to the present invention, which comprises a printed circuit for driving light emitting diodes, characterized in that said printed circuit has, along its longer sides, means for engagement with a complementary thread of a lamp-holder and, along one of its shorter sides, elastic means for contact with a lower electric power supply region of said lamp-holder.

### BRIEF DESCRIPTION OF THE DRAWINGS

Further characteristics and advantages of the invention will become better apparent from the description of the preferred embodiment of an adapter particularly for adapting light emitting diodes to commercial lamp-holders illustrated by way of example in the accompanying drawings, in which the only FIGURE is a side view of the adapter itself.

### DESCRIPTION OF THE PREFERRED EMBODIMENTS

An adapter particularly for adapting light emitting diodes (LEDs) 5 to commercial lamp-holders comprises a printed circuit 1 for driving LEDs of a type known per se and has, along its longer sides, engagement means 2 for engagement with a standard complementary thread of a lamp-holder (of a type known per se and not shown) and, along one of its shorter sides, elastic means 3 for contact with a lower electric power supply region of the lamp-holder.

The engagement means 2 comprise thread regions (designated by the same reference numeral 2) provided one along each longer side of the printed circuit 1. The pitch and the diameter of the thread are the ones standardized for the bulbs mentioned earlier.

The elastic contact means 3 comprise at least one spring (designated by the same reference numeral 3), which is fixed at one end to an electrical contact of the printed circuit 1 and carries, at its other end, a connector 4 that provides an electrical contact with the lower and central electric power supply region of the lamp-holder. In the printed circuit 1 it is possible to provide advantageously, as in the accompanying figure, recesses 6 that allow a better mechanical seating of the spring 3 and a simpler mechanical and electrical fixing thereof to said printed circuit 1.

In order to constitute the second point for drawing electric power from the thread of the lamp-holder, at least one of the thread regions 2 is metallized so as to constitute said pole for electrical connection of the printed circuit 1 to the lamp-holder.

It must be stressed that the printed circuit 1 has such a thickness (a few millimeters) that the threads 2 provide a stable mating with the inner complementary thread of the lamp-holder.

The electric power supply is fed to the printed circuit 1 by means of the metallization of at least one of the threads 2 and by means of the connector 4 through the spring 3.

It must be specified that the printed circuit 1 is made of insulating material and that the electric connections are provided thereon by metallization of the edges. The electrical and electronic components of the circuit 1 are then soldered onto the paths by means of automated systems for ensuring its durability and robustness. The LED 5 is fixed in the same manner on the side opposite to the side where the spring 3 is present.

An adapter according to what has been described above has some advantages over bulbs or over the replacement of lamp-holders as previously mentioned: first of all, the cap known in currently commercially available LED lamps is eliminated, and therefore the dimensions of the resulting assembly adapted to replace the incandescent bulbs described above are reduced.

As is known, traditional bulbs emit light over 360°, while LEDs have a directional light emission. The constructive method of the present invention allows the orientation of the LED (or LEDs) arranged on the adapter with respect to the arrangement of the lamp, so as to maximize their brightness in the preferred direction by acting simply on the engagement of the thread in the lamp-holder, since the metallization of at least one of the regions 2 allows electrical connection to the complementary thread of the lamp-holder and the spring 3 allows keeping the connector 4 integral with the other power supply pole of the lamp-holder. Therefore, once the threads 2 have engaged the complementary thread of the lamp-holder and the connector 4 has abutted against the other lower power supply pole of the lamp-holder, by simply rotating the circuit 1 the position of the LED 5 will be adjusted so as to maximize its brightness for the function that it must perform.

This simple operation is particularly advantageous because rendering the panel uniform from a lighting point of view, for example, in electrical panels with luminous indicators, is simple and quick thanks to the use of the spring 3.

Moreover, by operating again on the rotation it is possible to adjust the depth of the insertion in the lamp-holder, because the lower connection is constituted by the connector 4 carried by the spring 3, which allows a mechanically and electrically stable connection which however is movable in a direction perpendicular to the lamp-holder and therefore makes it possible to adjust its insertion in the lamp-holder.

Moreover, with respect to LED lamps of the known type, the present invention advantageously eliminates the presence of a cap, which increases the longitudinal dimensions. All the details may be replaced with other technically equivalent elements.

In practice, the materials used, as well as the dimensions, may be any according to the requirements.

The disclosures in Italian Utility Model Application No. VR2011U000006 from which this application claims priority are incorporated herein by reference.

What is claimed is:

1. An adapter for adapting light emitting diodes to commercial lamp-holders, comprising a printed circuit for driving light emitting diodes, wherein said printed circuit has, along its longer sides, engagement means for engagement with a complementary thread of a lamp-holder and, along one of its shorter sides, elastic contact means for contact with a lower electric power supply region of said lamp-holder.

2. The adapter according to claim 1, wherein said engagement means comprise thread regions provided one along each longer side of the printed circuit.

3. The adapter according to claim 1, wherein said elastic contact means comprise at least one spring, which is fixed at one end to an electrical contact of said printed circuit and carries, at its other end, a connector adapted to provide electrical contact with said lower electric power supply region of said lamp-holder.

4. The adapter according to claim 2, wherein at least one of said thread regions is metallized so as to constitute the second pole for the electric power connection of said printed circuit to said lamp-holder.
